(19) United States
(12) Patent Application Publication
(10) Pub. No.: US 2016/0349080 A1
(43) Pub. Date: Dec. 1, 2016

(54) MAGNETIC SENSOR FOR DETERMINING THE RELATIVE POSITION BETWEEN A MAGNETIZED TARGET AND A MEASUREMENT SYSTEM

(71) Applicant: ELECTRICFIL AUTOMOTIVE, Miribel Cedex (FR)

(72) Inventors: Sébastien GUERIN, Lyon (FR); Harijaona RAKOTOARISON, Beligneux (FR); Mathieu LE NY, Villeurbanne (FR)

(73) Assignee: ELECTRICFIL AUTOMOTIVE, Miribel Cedex (FR)

(21) Appl. No.: 15/117,547

(22) PCT Filed: Feb. 27, 2015
(86) PCT No.: PCT/FR2015/050474

§ 371 Date: Aug. 9, 2016

(30) Foreign Application Priority Data
Feb. 28, 2014 (FR) 14 51622

(51) Int. Cl. G01D 5/14

(52) U.S. Cl. CPC G01D 5/14

(57) ABSTRACT

The invention relates to a magnetic sensor for determining position along a travel path (T) between a target (2) and a measurement system (3) for measuring the amplitude of the magnetic field created or modified by the target.

The sensor comprises:
a creation system for creating a magnetic field in a direction (M) perpendicular to the travel path (T) and with an intensity that varies with a parabolic relationship;
a measurement system (3) comprising at least two mutually spatially offset measurement elements (3a), (3b) that are sensitive to the amplitude of the magnetic field in a given direction; and
a processor circuit suitable for performing differential processing on the signals delivered by the measurement elements in order to obtain a linear variation signal giving the position of the target along the travel path.

The present invention relates to the technical field of contactless magnetic sensors suitable for determining the position of a part moving along a determined path.

The present invention finds particularly advantageous, but nonexclusive, applications in the field of motor vehicles, for the purpose of fitting to various movable members of position that needs to be known and forming parts, by way of example, of a gearbox, of the engine, of a controlled clutch, of power assisted steering, of an attitude adjustment system, etc.

The state of the art has proposed numerous variant embodiments of such contactless magnetic sensors. In general manner, a magnetic sensor makes it possible, without making contact, to determine the relative position on an angular, linear, or curvilinear travel path between a target and a system for measuring the magnetic field created or modified by the target. The target or the measurement system is secured to the movable part of position that is to be determined. The target forms a portion of a system for creating a magnetic field along the travel path. The measurement system is connected to a signal processor circuit for processing signals delivered by the measurement system in order to deliver a signal that is a function of the relative position between the target and the measurement system.

In a first category of solutions, as described by way of example in documents US 2001/0038281, US 2004/0164727, the measurement system includes a cell with a single sensitive element adapted to measure the amplitude of the magnetic field. The advantages of such sensors lie in the simplicity of fabrication and insensitivity to temperature, while the main drawback lies in sensitivity to variations in the air gap and to disturbing magnetic fields that induce large amounts of nonlinearity error.

In a second category of solutions, as described by way of example in documents EP 0 979 988 and FR 2 953 286, the measurement system detects the orientation of the magnetic field by measuring the various components of the magnetic field. The advantage of such sensors is in sensitivity to temperature and to air gap variations. Nevertheless, the sensor is sensitive to disturbing magnetic fields and presents difficulty in determining the correct orientation for the magnetic field.

U.S. Pat. No. 3,419,798 discloses a magnetic system for detecting linear movement between a magnetic target and a system for measuring the amplitude of a magnetic field, which system has two Hall effect sensors. The magnetic target is made in the form of a magnetized strip extending along a shape that is parabolic or hyperbolic. The direction of the magnetic field is parallel to the width of the target as considered between its two opposite longitudinal edges.

Thus, the magnet is magnetized in a direction perpendicular to the plane formed by the stroke and the direction of the Hall effect sensor. Such an arrangement implies a low value for the magnetic field seen by the sensor, which makes it necessary to work with an air gap that is very small. Furthermore, the magnetization is obtained by the deformation of the magnet, giving rise to mechanical stresses in the material, thereby disturbing the magnetization. Finally, the use of studs for deforming the magnet and making holes in the magnet in order to fasten it give rise to disturbances in the magnetic field supplied by the magnet so that it is not possible to obtain a controlled three-dimensional distribution of the magnetic field.

U.S. Pat. No. 6,323,643 describes a position sensor having a magnet fastened to a rotor rotating about an axis of rotation. The magnet possesses a polarised surface of semi-parabolic shape situated facing a stationary Hall effect sensor. Such a position sensor is sensitive to external magnetic fields since it has only one Hall effect sensor.

The present invention seeks to remedy the drawbacks of the state of the art by proposing a magnetic position sensor that is insensitive to temperature, to air gap variations, and to disturbing magnetic fields.

To achieve such an object, the invention seeks to use a magnetic signature of intensity that varies with a parabolic relationship and to determine the difference between amplitude measurements under consideration of the magnetic field at at least two different points in three-dimensional space.

The sensor of the invention is a magnetic sensor for determining the angular or linear relative position along a travel path between a target and a measurement system for measuring the amplitude of the magnetic field created or modified by the target that presents an outside shape, the target forming part of a creation system for creating a magnetic field that varies at least along the travel path, the measurement system comprising at least two mutually spaced apart measurement elements that are sensitive to the amplitude of the magnetic field in a given direction, the measurement system being connected to a processor circuit for processing signals delivered by the measurement system. According to the invention:
the creation system creates a magnetic field of intensity that varies with a parabolic relationship in a direction perpendicular to the travel path and crossing the outside shape of the target and the air gap defined between the outside shape of the target and of the measurement system; and
the processor circuit is suitable for performing differential processing on the signals delivered by the measurement elements in order to obtain a linear variation signal giving the position of the moving body along the travel path.

The sensor of the invention further comprises, in combination, one or more of the following additional characteristics:
the creation system creates a magnetic field with an intensity that varies with a parabolic relationship along the travel path;
the processor circuit is suitable for performing measurement ratio processing on the signals delivered by the measurement elements;
the creation system creates a magnetic field of direction that is perpendicular to a linear or rotary travel path;
the creation system creates a magnetic field of direction that is perpendicular to a travel path followed on a surface, and in that the measurement system includes at least three non-aligned measurement elements;
the creation system creates a magnetic field of direction that is perpendicular to a travel path combining a movement in rotation and a movement in translation, and in that the measurement system includes at least three non-aligned measurement elements;
the creation system creates a magnetic field of direction that is perpendicular to a travel path combining two movements in rotation, and the measurement system includes at least three non-aligned measurement elements;
the creation system includes a magnetized target with an intensity of magnetization that is constant and with at least one outside shape that follows a parabolic relationship;
the creation system includes a magnet possessing an intensity of magnetization that is constant and a ferromagnetic target co-operating with the magnet to define an air gap in which the measurement system is placed, the magnet presenting a direction of magnetization that is oriented perpendicularly to the outside shape of the ferromagnetic target, which shape follows a parabolic relationship;
the creation system includes a magnetized target presenting a magnetic field of intensity that is distributed in a parabolic relationship; and
the creation system includes at least one coil and a target enabling parabolic variation to be created in the intensity of the magnetic field at the measurement system.

Various other characteristics appear from the description given below with reference to the accompanying drawings, which show, as nonlimiting examples, embodiments of the subject matter of the invention.

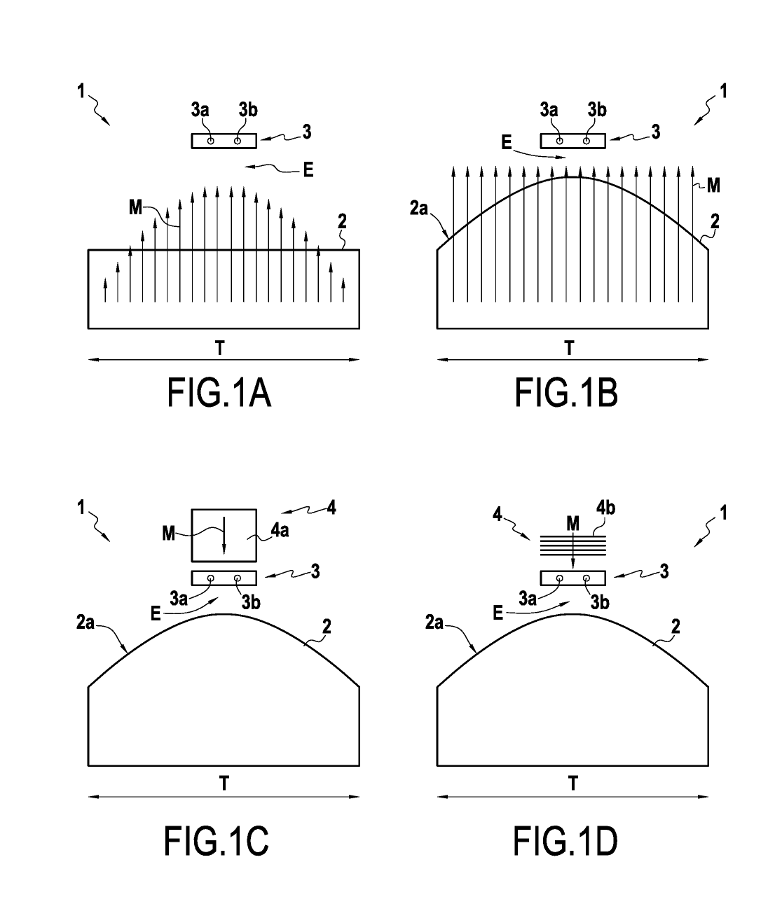

FIG. 1A shows a first embodiment of a position sensor in accordance with the invention.

FIG. 1B shows a variant second embodiment of a position sensor in accordance with the invention.

FIG. 1C shows a variant third embodiment of a position sensor in accordance with the invention.

FIG. 1D shows a variant fourth embodiment of a position sensor in accordance with the invention.

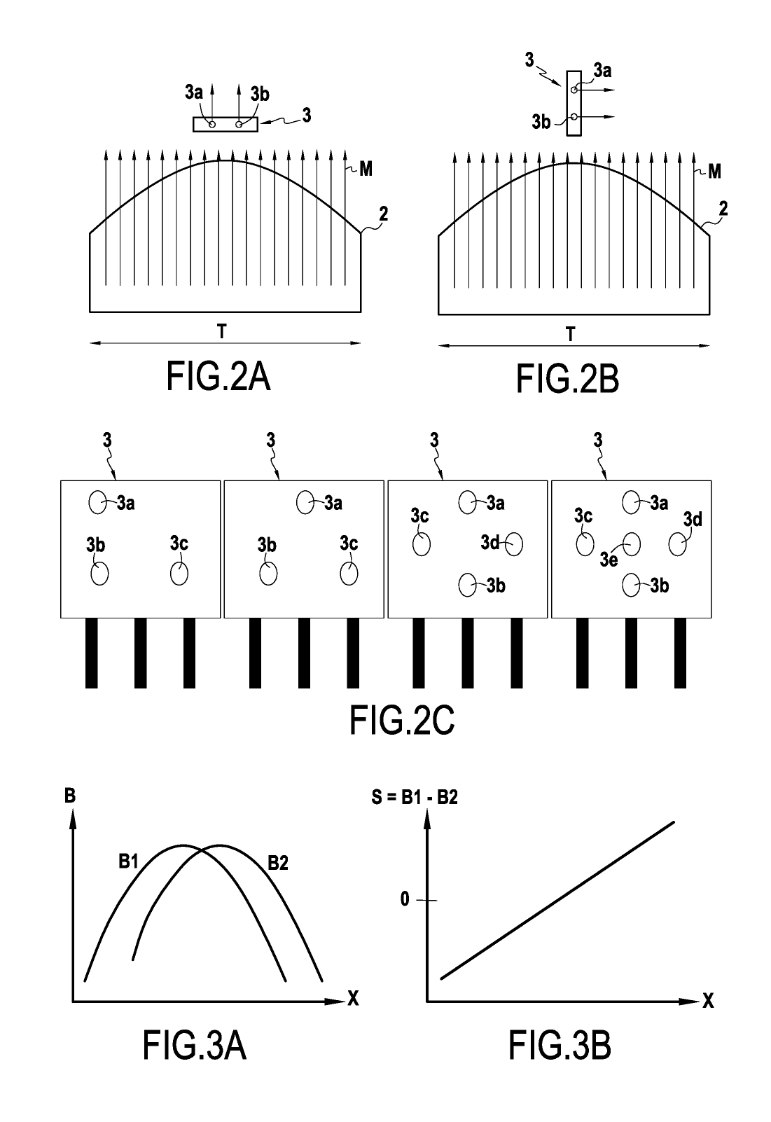

FIGS. 2A and 2B are diagrammatic views of two equivalent ways of mounting a measurement system forming part of the position sensor in accordance with the invention.

FIG. 2C shows various different ways of mounting measurement elements of a measurement system adapted to determining the path of a moving body travelling on a surface.

FIG. 3A is a diagram showing the parabolic variation of the magnetic field as a function of the stroke of a moving body.

FIG. 3B is a diagram showing the difference between signals of parabolic shape as a function of the stroke of the moving body.

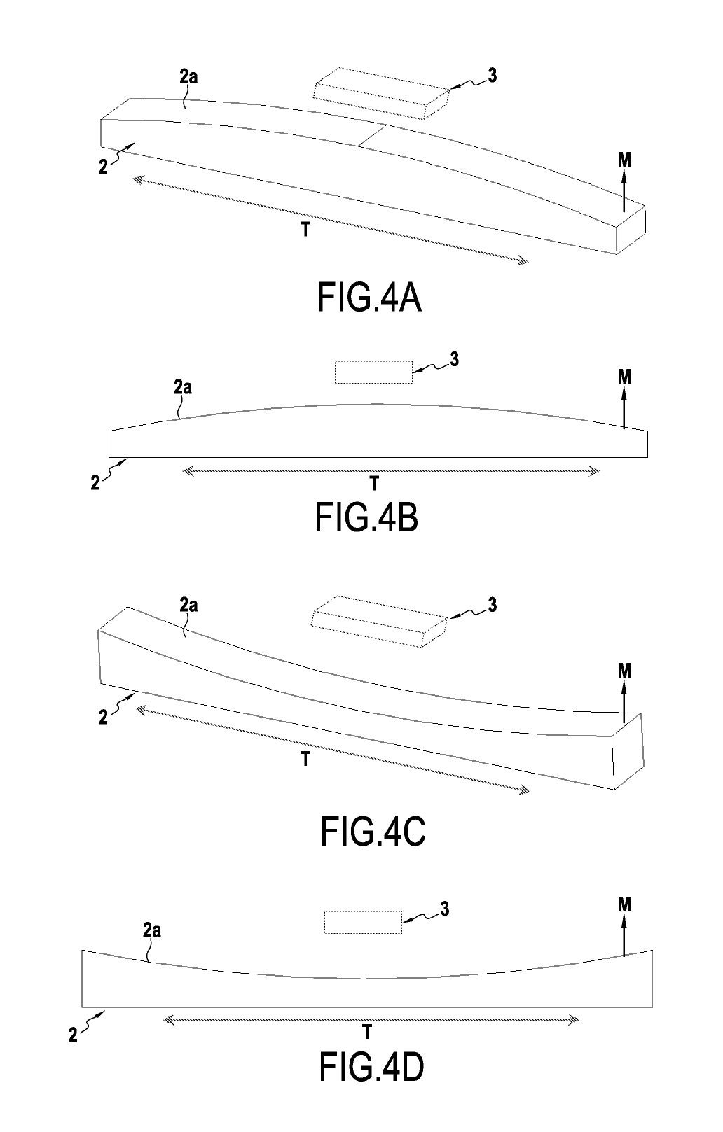

FIGS. 4A and 4B are respectively a perspective view and a face view of an embodiment of a linear position sensor that includes a target of convex shape.

FIGS. 4C and 4D show an embodiment of a linear position sensor using a target of concave shape.

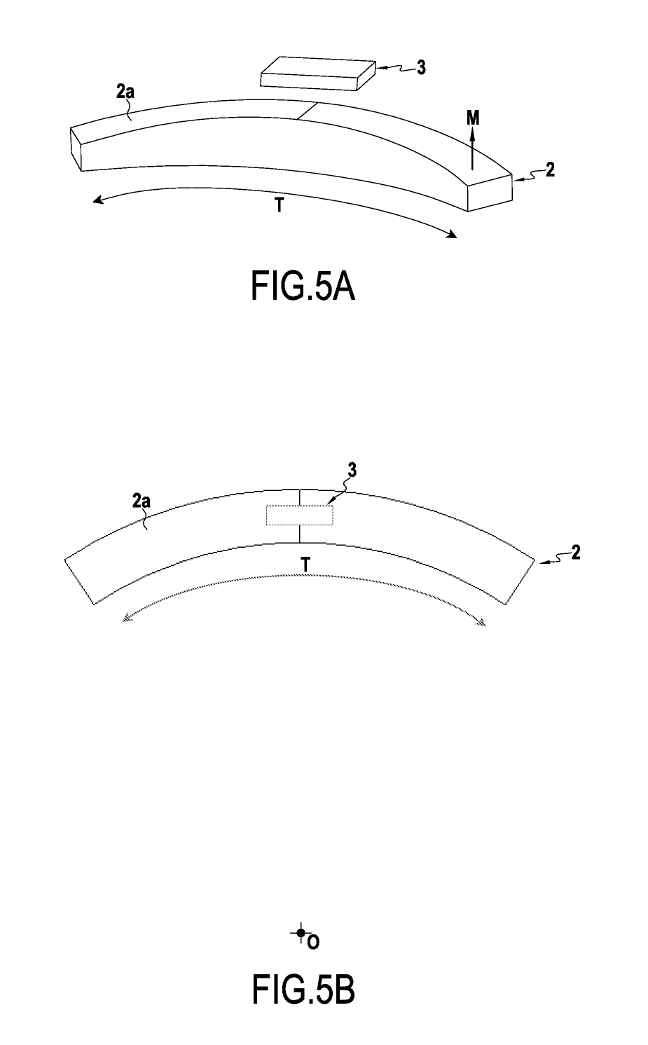

FIGS. 5A and 5B are respectively a perspective view and a plan view of an embodiment of a radial position sensor.

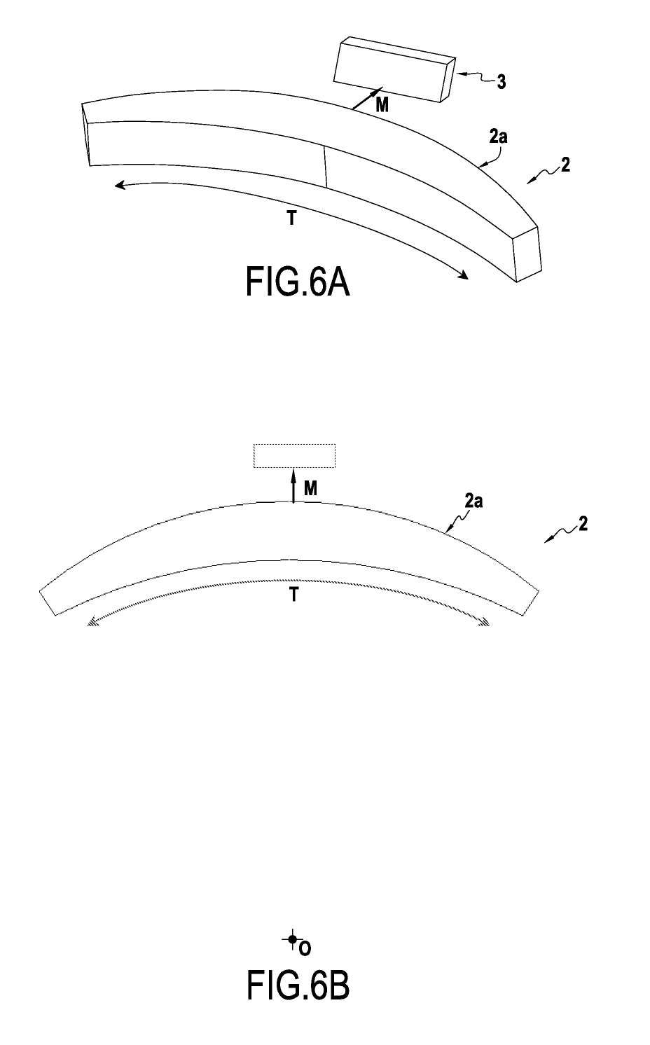

FIGS. 6A to 6B show respectively a perspective view and a plan view of an embodiment of a radial position sensor.

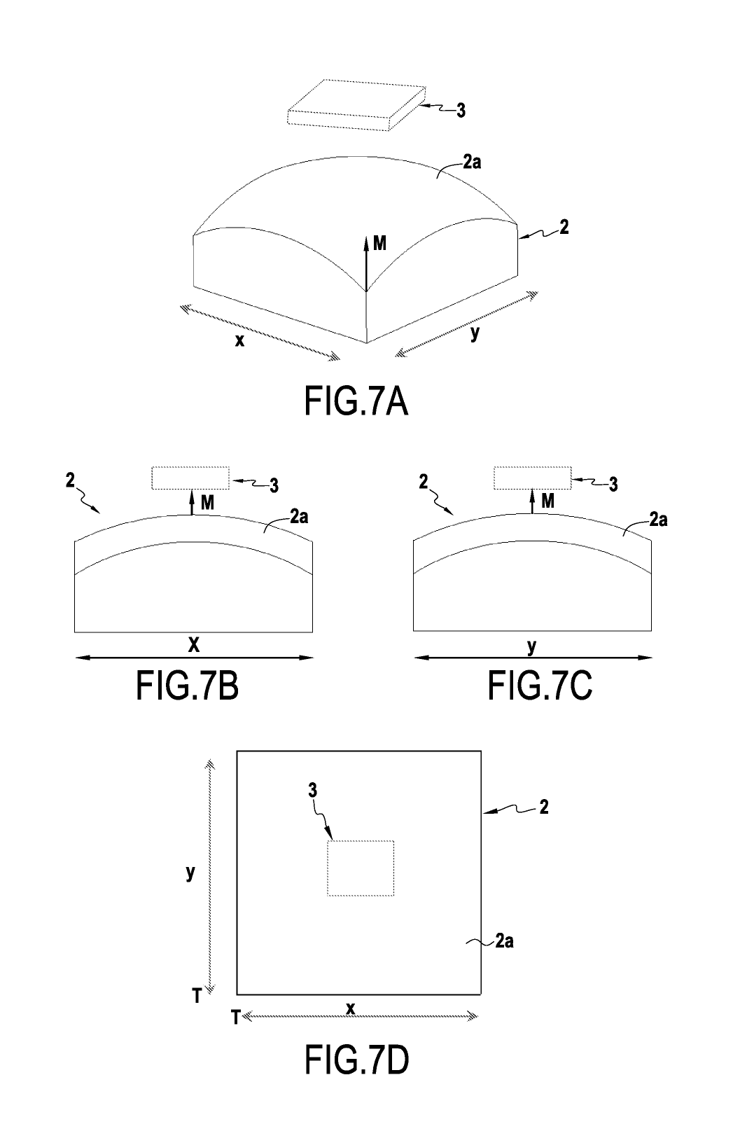

FIGS. 7A to 7D are respectively a perspective view, a side view, a face view, and a plan view of a position sensor for a moving body travelling in a plane.

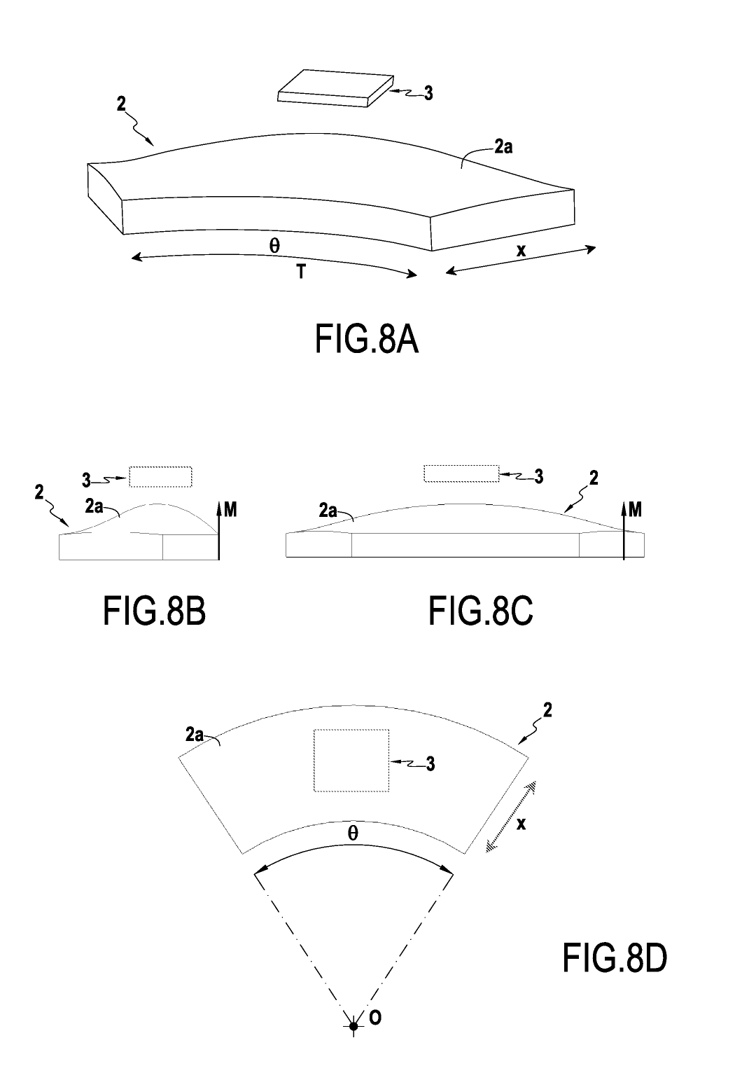

FIGS. 8A to 8D are respectively a perspective view, a side view after a linear movement, a face view from the axis of rotation, and a plan view of an embodiment of a position sensor for a moving body that possesses a travel path that is linear and rotary.

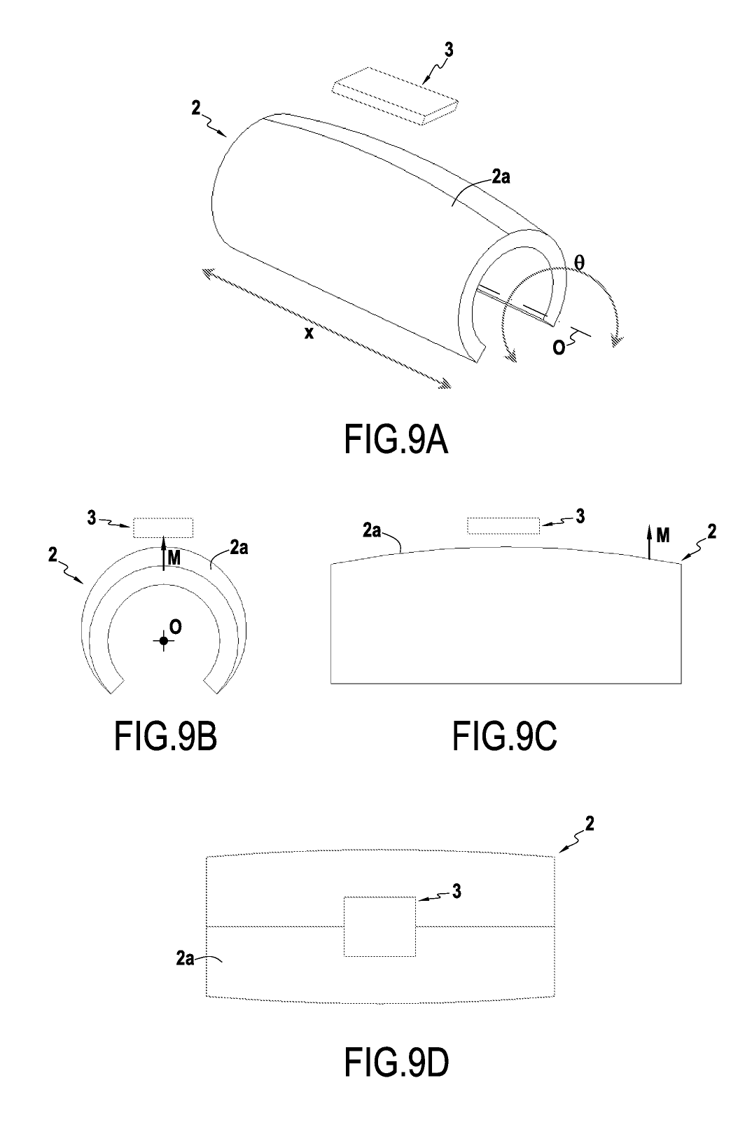

FIGS. 9A to 9D are respectively a perspective view, a side view, a face view, and a plan view of a position sensor for a moving body presenting a path that is linear and rotary about an axis.

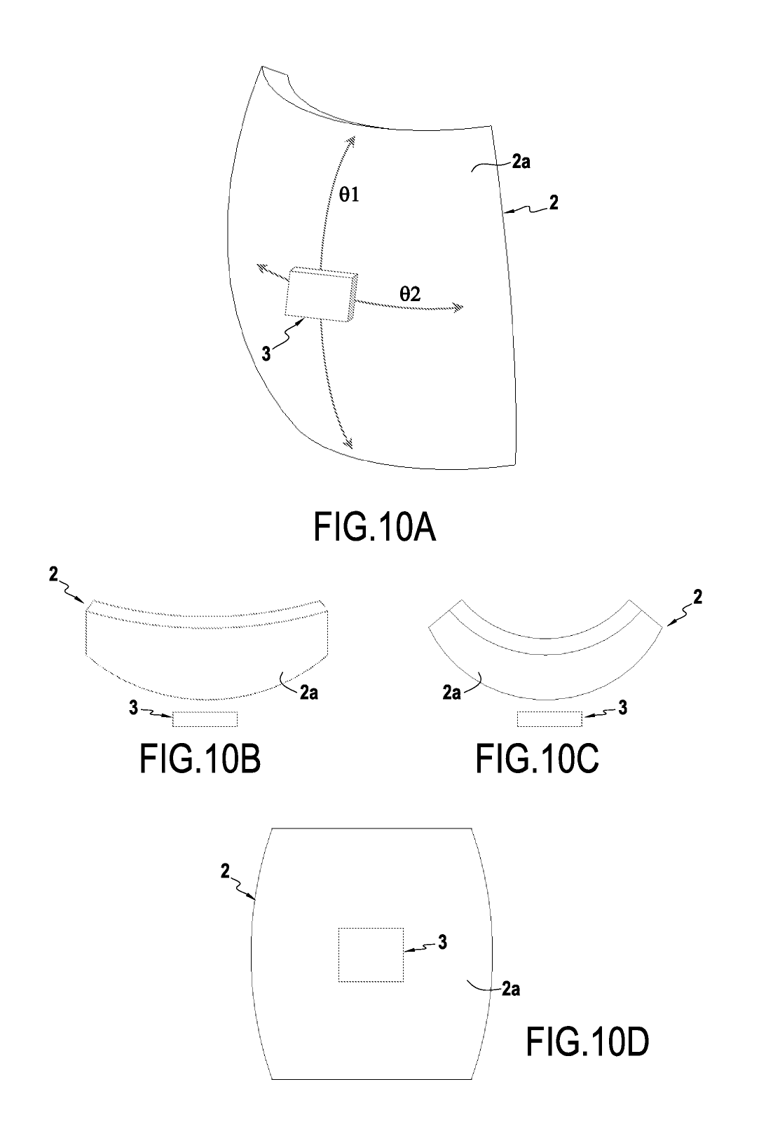

FIGS. 10A to 10D are respectively a perspective view, a side view, a face view, and a plan view of an embodiment of a sensor enabling a travel path to be determined that involves two rotations.

As can be seen from the drawings, the subject matter of the invention relates to a magnetic sensor 1 capable of acting without contact to determine the position of a moving body travelling on a path T that may be angular, linear, or curvilinear, as shown by the different embodiment variants that can be seen in the drawings. The magnetic sensor 1 comprises a target 2 and a measurement system 3 for measuring a magnetic field that is created or modified by the target.

In a first embodiment, the target 2 forms part of or is securely mounted on the moving body of position that is to be determined, while the measurement system 3 is stationary relative to the target, which moves. In a second embodiment, the measurement system 3 forms part of or is securely mounted on the moving body of position that is to be determined, while the target 2 is stationary relative to the measurement system 3, which moves. The sensor 1 of the invention thus serves to determine the relative position between the target 2 and the system 3 for measuring the magnetic field. For the purposes of simplification and of clarity, it is considered in the description below that the sensor is adapted to determine the position of the moving body corresponding either to the target 2 moving relative to the measurement system 3, which remains stationary, or else to the measurement system 3 moving relative to the stationary target 2.

In conventional manner, the target 2 and the measurement system 3 are positioned to define an air gap

E that is crossed by the magnetic field. For this purpose, the target 2 has a shape or an outside surface 2a defining a portion of the air gap and facing towards the measurement system 3.

The target 2 forms a portion of a creation system 4 for creating a magnetic field. According to a characteristic of the invention, the creation system 4 creates a magnetic field in a direction M perpendicular to the travel path T and with an intensity that varies with a parabolic relationship. The direction M of the magnetic field crosses the outside shape 2a of the target and also crosses the air gap E defined between the target 2 and the measurement system 3. The creation system 4 may be made in various ways.

In the example shown in FIG. 1A, the creation system 4 includes a magnetized target 2 made by a magnet delivering a magnetic field presenting a direction of magnetization M and an amplitude or an intensity that varies with a parabolic relationship along at least a direction M crossing the air gap E and the outside shape 2a of the target. The target 2 thus delivers a magnetic field of intensity that is distributed with a parabolic relationship in at least one direction. This parabolic variation in the intensity of the magnetic field is created in order to be detected or measured by the measurement system 3.

In the example shown in FIG. 1B, the creation system 4 comprises a magnetized target 2 made by a magnet presenting an outside shape 2a following a parabolic relationship. This magnet possesses intensity of magnetization that is constant with a direction of magnetization M crossing the air gap E and the outside shape 2a of the target. The target 2 thus delivers a magnetic field of intensity that is distributed with a parabolic relationship in at least one direction. This parabolic variation in the intensity of the magnetic field is created in order to be detected or measured by the measurement system 3.

In the example shown in FIG. 1C, the creation system 4 comprises a magnet 4a and a ferromagnetic target 2. It should be observed that the magnet 4a is considered as forming part of the measurement system 3.

By way of example, the ferromagnetic target 2 presents an outside shape 2a following a parabolic relationship. The magnet 4a possesses intensity of magnetization that is constant with a direction of magnetization M crossing the air gap E and the outside shape 2a of the target. The target 2 thus delivers a magnetic field of intensity that is distributed with a parabolic relationship in at least one direction. This parabolic variation in the intensity of the magnetic field is created in order to be detected or measured by the measurement system 3.

In the example shown in FIG. 1D, the creation system 4 includes at least one coil 4b and a ferromagnetic or conductive target 2. It should be observed that the coil 4b is considered as forming part of the measurement system 3. By way of example, the target 2 presents an outside shape 2a following a parabolic relationship. The coil 4b generates a magnetic field that is constant or that varies in time in a direction M crossing the air gap E and the outside shape 2a of the ferromagnetic part. The target 2 thus delivers a magnetic field of intensity that is distributed with a parabolic relationship in at least one direction. This parabolic variation in the intensity of the magnetic field is created in order to be detected or measured by the measurement system 3.

In the examples shown in FIGS. 1C and 1D, the parabolic variation in the intensity of the magnetic field along the stroke of the moving body is obtained by the parabolic shape of the target 2. Naturally, this parabolic variation could be obtained in some other manner and it could depend on the nature of the various materials used for the target 2.

Thus, the creation system 4 makes it possible to obtain a parabolic distribution of the magnetic field B in a measurement direction x such that:

B(x)=ax²+bx+c.

In an advantageous variant implementation, the creation system 4 creates a magnetic field with an intensity that varies with a parabolic relationship along the travel path T. Thus, the measurement direction x corresponds to the travel path T. Naturally, as can be understood from the description below, the measurement direction x may be offset relative to the travel path T. Under such circumstances, the measurement system 3 performs calculations in order to determine the position of the moving body relative to the travel path.

Naturally, the distribution of the magnetic field created by the system 4 depends on the nature of the path of the moving body. In the above example shown in FIGS. 1A to 1D, the parabolic magnetic field varies in a direction making it possible to determine the path of the moving body travelling along a path that is either linear or curved.

When the path of the moving body runs along a surface such as a plane, a cylinder, or a sphere, for example, then the creation system 4 creates a magnetic field of parabolic shape that is distributed along the travel surface T of the moving body. Thus, the creation system 4 makes it possible to obtain a parabolic distribution of the induction B on the travel surface x,y such that:

B(xy)=ax²+by²+cxy+dy+ex+f.

The amplitude of the magnetic field of intensity that varies with a parabolic relationship is measured by the measurement system 3. The measurement system 3 has at least two measurement elements 3a, 3b, 3c, . . . that are spaced apart from one another. Each measurement element 3a, 3b, 3c . . . is sensitive to the amplitude of the magnetic field in a given direction. For example, these measurement elements are Hall effect cells, magneto resistive effect cells (anisotropic (AMR), giant (GMR), tunneling (TMR)), or detector coils.

In a first embodiment, the measurement elements 3a, 3b, 3c, . . . are offset from one another in the travel direction T as shown in FIG. 2A. In this example, the measurement elements 3a, 3b, 3c, . . . are offset in a direction perpendicular to the direction of magnetization M. In a second embodiment, the measurement elements 3a, 3b, 3c, . . . are offset from one another in a direction perpendicular to the travel direction T as shown in FIG. 2B. In this example, the measurement elements 3a, 3b, 3c, . . . are offset in a direction parallel to the direction of magnetization M. Mounting the measurement elements 3a, 3b, 3c, . . . in these two embodiments make it possible to obtain measurements of the amplitude of the magnetic field that are equivalent.

The measurement system 3 has at least two measurement elements 3a, 3b, 3c, . . . for determining the position of the moving body presenting a travel path T in one direction. When the path of the moving body follows a surface, then the measurement system 3 has at least three measurement elements, for example four or five measurement elements 3a, 3b, 3c, 3d, 3e (FIG. 2C) that are mutually offset in order to determine the position of the moving body. The number and the positioning of the measurement elements 3a, 3b, 3c, 3d, 3e are selected and adapted as a function of the path of the moving body. Thus, when the path of the moving body follows two directions x,y in a plane, it is then advantageous to position at least two measurement elements along each direction.

As can be seen from FIG. 3A, each measurement element 3a, 3b, 3c, . . . thus delivers an output signal Sa, Sb, Sc, . . . having the form of a parabola that is a function of the position of the measurement system 3 relative to the moving body along the travel path T.

The measurement system 3 is connected to a processor circuit (not shown) for processing the signals delivered by the measurement elements 3a, 3b, 3c, . . . . In accordance with the invention, the processor system is suitable for performing differential processing on the signals delivered by the measurement elements in order to obtain a linear variation signal S giving the position x of the moving body along the travel path. As can be seen from FIG. 3B, the difference between signals of parabolic shape gives a linear function as a function of the stroke of the moving body.

The sensor 1 of the invention thus makes it possible to obtain linearity in the output signal giving the position of the moving body over the entire travel path, with the advantage that such an output signal is insensitive to disturbing magnetic fields.

In an advantageous variant implementation, the processor circuit is suitable for performing measurement ratio processing on the signals Sa, Sb, Sc, . . . delivered by the measurement elements. In other words, the processor circuit seeks to provide the difference between two measurement signals divided by the sum of those two measurement signals or by some other measurement signal. Thus, the output signal S is no longer a mere differential signal, but it is a ratio between the difference between two measurements divided by their sum or by some other measurement. Thus, the output signal S may be expressed as follows:

S=(a.Sa−b.Sb)/(c.Sa+d.Sb) or

S=(a.Sa−b.Sb)/c.Sc,

with a, b, c and d being constants.

In this variant, the proportional variation of the magnetic field due to any variation in temperature or in air gap is thus compensated by using such a measurement ratio as an output signal.

The examples below describe several variant embodiments of the sensor in accordance with the invention as a function of various travel paths of the moving body. In the drawings below, the parabolic distribution of the magnetic field is obtained by the outside shape 2a of a magnetic target 2 presenting a direction of magnetization M, as described with reference to FIG. 1B. This makes it possible to visualise the shape of the distribution of the magnetic field by means of the outside shape 2a of the magnetic target. Naturally, these different variant embodiments of the sensor of the invention may include a creation system 4 in accordance with FIG. 1A, 1C, or 1D.

In the example shown in FIGS. 4A-4B and 4C-4D, the travel path T is linear so that the creation system 4 creates a magnetic field of parabolic shape in which the direction of magnetization M is perpendicular to a linear path T. The creation system 4 includes a target 2 presenting an outside shape 2a that, in the direction T and as a function of the stroke of the moving body, has a parabolic shape with the measurement system 3 placed facing it. In the example shown in FIGS. 4A-4B, a parabolic outside shape 2a of the target 2 is convex, whereas in the example shown in FIGS. 4C-4D, the parabolic outside shape of the target 2 is concave.

In the example shown in FIGS. 5A-5B, the travel path T is curved and in particular along a circular segment about an axis 0 so that the creation system 4 creates a magnetic field of parabolic shape with its direction of magnetization M perpendicular to a circular or rotary path T. The creation system 4 includes a target 2 presenting an outside shape 2a that, in the direction T and as a function of the stroke of the moving body, has a parabolic shape with the measurement system 3 placed facing it.

It should be observed that in the example shown in FIGS. 5A-5B, the parabolic outside shape 2a of the target 2 is made axially, i.e. along the axis O, whereas in the example shown in FIGS. 6A-6B, the parabolic outside shape 2a of the target 2 is made radially. In this example, the parabolic outside shape 2a is situated between the axis of rotation O and the measurement system 3.

In the examples shown in FIGS. 5A-5B and 6A-6B, the target 2 presents a parabolic outside shape 2a that is convex, whereas it is clear that the parabolic outside shape 2a could be concave.

In the example shown in FIGS. 7A to 7D, the travel path T runs along a surface that is a plane x,y. In this example, the creation system 4 creates a magnetic field of parabolic shape in which the direction of magnetization M is perpendicular to the travel path T, i.e. to the plane x,y. Such creation system 4 makes it possible to obtain a parabolic distribution of the magnetic field in a measurement plane x,y. The creation system 4 includes a target 2 presenting an outside shape 2a that, in the plane x,y and as a function of the stroke of the moving body, is parabolic with the measurement system 3 placed facing it. The parabolic outside shape 2a of the target 2 results from combining parabolic shapes extending in the directions x and y. In the example shown in FIGS. 7A to 7D, the parabolic outside shape 2a of the target 2 is convex, whereas it is clear that the parabolic outside shape 2a of the target 2 could be concave. In this embodiment shown in FIGS. 7A to 7D, the measurement system includes at least three non-aligned measurement elements, as shown in FIG. 2C.

In the example shown in FIGS. 8a to 8D, the travel path T runs along a surface defined by a rotation through an angle θ of center O and by a linear movement x that is radial relative to the angular movement θ. In this example, the creation system 4 creates a magnetic field of parabolic shape in which the direction of magnetization M is perpendicular to the travel path T, i.e. to the plane x,y. The creation system 4 includes a target 2 presenting an outside shape 2a that, on the surface x,θ and as a function of the stroke of the moving body, is parabolic with the measurement system 3 placed facing it. The parabolic outside shape 2a of the target 2 that is made axially results from combining parabolic shapes extending in the directions x and θ. In the example shown in FIGS. 8A to 8D, the parabolic outside shape 2a of the target 2 is convex, whereas it is clear that the parabolic outside shape 2a of the target 2 could be concave. In this embodiment shown in FIGS. 8A to 8D, the measurement system includes at least three non-aligned measurement elements, as shown in FIG. 2C.

FIGS. 9A to 9D show another embodiment in which the travel path T extends along a surface defined by a rotation θ about a center O and by a linear direction x that is axial, i.e. parallel to the axis O. In this example, the creation system 4 creates a magnetic field of parabolic shape in which the direction of magnetization M is perpendicular to the travel path T, i.e. to the surface x, θ. The creation system 4 includes a target 2 presenting an outside shape 2a that, on the surface x,θ and as a function of the stroke of the moving body, is parabolic with the measurement system 3 placed facing it. The parabolic outside shape 2a of the target results from combining parabolic shapes extending in the directions x and θ. In the example shown in FIGS. 9A to 9D, the parabolic outside shape 2a of the target 2 is convex, whereas it is clear that the parabolic outside shape 2a of the target 2 could be concave. In this embodiment shown in FIGS. 9A to 9D, the measurement system includes at least three non-aligned measurement elements, as shown in FIG. 2C.

FIGS. 10A to 10D show another embodiment in which the travel path T extends along a surface defined by combining a first rotation θ1 and a second rotation θ2. In this example, the creation system 4 creates a magnetic field of parabolic shape in which the direction of magnetization M is perpendicular to the travel path T, i.e. to the spherical surface θ1, θ2. The creation system includes a target 2 presenting an outside shape 2a that, on the surface θ1, θ2 and as a function of the stroke of the moving body, is parabolic with the measurement system 3 placed facing it. The parabolic outside shape 2a of the target 2 results from combining parabolic shapes extending in the directions θ1 and θ2. In the example shown in FIGS. 10A to 10D, the parabolic outside shape 2a of the target 2 is convex, whereas it is clear that the parabolic outside shape 2a of the target 2 could be concave. In this embodiment shown in FIGS. 10A to 10D, the measurement system includes at least three non-aligned measurement elements, as shown in FIG. 2C.

The invention is not limited to the embodiments described and shown since various modifications can be made thereto without going beyond its ambit.

1. A magnetic sensor for determining the angular or linear relative position along a travel path (T) between a target (2) and a measurement system (3) for measuring the amplitude of the magnetic field created or modified by the target (2) that presents an outside shape (2a), the target (2) forming part of a creation system (4) for creating a magnetic field that varies at least along the travel path, the measurement system comprising at least two mutually spaced apart measurement elements (3a, 3b, 3c, . . . ) that are sensitive to the amplitude of the magnetic field in a given direction, the measurement system being connected to a processor circuit for processing signals delivered, by the measurement system, wherein the magnetic sensor comprises:
the creation system (4) that creates a magnetic field of intensity that varies with a parabolic relationship in a direction (M) perpendicular to the travel path (T) and crossing the outside shape (2a) of the target and the air gap (E) defined between the outside shape of the target and of the measurement system (3); and
the processor circuit that performs differential processing on the signals delivered by the measurement elements in order to obtain a linear variation signal giving the position of the moving body along the travel path.

2. The magnetic sensor according to claim 1, wherein the creation system (4) creates a magnetic field with an intensity that varies with a parabolic relationship along the travel path (T).

3. The magnetic sensor according to claim 1, wherein the processor circuit is suitable for performing measurement ratio processing on the signals delivered by the measurement elements (3a, 3b, 3c, . . . ).

4. The magnetic sensor according to claim 1, wherein the creation system (4) creates a magnetic field of direction (N) that is perpendicular to a linear or rotary travel path (T).

5. The magnetic sensor according to claim 1, wherein the creation system (4) creates a magnetic field of direction (M) that is perpendicular to a travel path (T) followed on a surface, and in that the measurement system (3) includes at least three non-aligned measurement elements (3a, 3b, 3c, . . . ).

6. The magnetic sensor according to claim 1, wherein the creation system (4) creates a magnetic field of direction that is perpendicular to a travel path (T) combining a movement in rotation and a movement in translation, and in that the measurement system (3) includes at least three non-aligned measurement elements (3a, 3b, 3c, . . . ).

7. The magnetic sensor according to claim 1, wherein the creation system (4) creates a magnetic field of direction (M) that is perpendicular to a travel path (T) combining two movements in rotation, and in that the measurement system (3) includes at least three non-aligned measurement elements.

8. The magnetic sensor according to claim 1, wherein the creation system (4) includes a magnetized target (2) with an intensity of magnetization that is constant and with at least one outside shape that follows a parabolic relationship.

9. The magnetic sensor according to claim 1, wherein the creation system (4) includes a magnet (4 answers) possessing an intensity of magnetization that is constant and a ferromagnetic target (2) co-operating with the magnet to define an air gap in which the measurement system is placed, the magnet (4a) presenting a direction of magnetization (M) that is oriented, perpendicularly to the outside shape of the ferromagnetic target, which shape follows a parabolic relationship.

10. The magnetic sensor according to claim 1, wherein the creation system (4) includes a magnetized target (2) presenting a magnetic field of intensity that is distributed in a parabolic relationship.

11. The magnetic sensor according to claim 1, wherein the creation system (4) includes at least one coil (4b) and a target (2) enabling parabolic variation to be created in the intensity of the magnetic field at the measurement system (3).
